(19) United States
(12) Patent Application Publication
(10) Pub. No.: US 2026/0218399 A1
(43) Pub. Date: Jul. 30, 2026

(54) CARBON OXIDE REDUCTION ELECTRODE, CARBON OXIDE ELECTROLYZER CELL INCLUDING THE SAME, AND METHOD OF PREPARING CARBON OXIDE REDUCTION ELECTRODE

(71) Applicants: Samsung Electronics Co., Ltd., Suwon-si (KR); Seoul National University R&DB Foundation, Seoul (KR)

(72) Inventors: Noho LEE, Suwon-si (KR); Yunjeong Hwang, Seoul (KR); Juhyung Choi, Seoul (KR); Jaeeun Kim, Suwon-si (KR); Kanghee Cho, Suwon-si (KR); Hyukjae Kwon, Suwon-si (KR); Dayeon Kim, Seoul (KR); Sejin Park, Seoul (KR)

(21) Appl. No.: 19/435,968

(22) Filed: Dec. 30, 2025

(30) Foreign Application Priority Data
Jan. 24, 2025 (KR) 10-2025-0011695

(51) Int. Cl. C25B 11/075; C25B 3/03; C25B 3/26; C25B 11/032; C25B 11/037; C25B 11/052; C25B 11/056; C25B 11/065

(52) U.S. Cl. CPC C25B 11/075; C25B 3/03; C25B 3/26; C25B 11/032; C25B 11/037; C25B 11/052; C25B 11/056; C25B 11/065

(57) ABSTRACT

A carbon oxide reduction electrode (CORE), a carbon oxide electrolyzer cell including the CORE, and a method of preparing a CORE. The CORE includes a gas diffusion layer (GDL) including a microporous substrate (MPS) that includes conductive fibers, and a microporous catalyst layer (MPCL) on the GDL, wherein the MPCL includes conductive particles and catalyst particles and has a thickness of 10 micrometers or more.

### CROSS-REFERENCE TO RELATED APPLICATION

This application is based on and claims priority under 35 U.S.C. § 119 to Korean Patent Application No. 10-2025-0011695, filed on Jan. 24, 2025, in the Korean Intellectual Property Office, the disclosure of which is incorporated by reference herein in its entirety.

### BACKGROUND

### 1. Field

The disclosure relates to a carbon oxide reduction electrode, a carbon oxide electrolyzer cell including the carbon oxide reduction electrode, and a method of preparing a carbon oxide reduction electrode.

### 2. Description of the Related Art

When fossil fuels are used or consumed greenhouse gases such as carbon dioxide are generated and emitted into the environment. Greenhouse gases cause climate change such as global warming.

The fossil fuels include multi-carbon compounds that are obtained through petrochemical processes, that is, the refining of crude oil to provide the fossil fuels. Carbon dioxide may be converted into multi-carbon compounds and various methods are being investigated to convert carbon dioxide into multi-carbon compounds.

### SUMMARY

A carbon oxide reduction electrode (CORE) is used to convert carbon oxides such as carbon monoxide and/or carbon dioxide into other carbon containing compounds. The CORE has a structure in which a catalyst layer is disposed on a gas diffusion layer (GDL) having hydrophobicity. Carbon oxides diffusing through the GDL react with electrons and electrolytes in the catalyst layer to produce carbon containing, e.g., compounds with at least two carbons (or multi-carbon compounds). In order to improve the efficiency of a carbon oxide reduction reaction, it is common to use a catalyst layer having a thin thickness. However, although a catalyst layer having a thin thickness may improve the efficiency of a carbon oxide reduction reaction, a relative thin catalyst layer may result in flooding. Flooding makes a gas diffusion electrode wet with an electrolyte, which in turn may make a catalytic reaction more difficult, e.g., less efficient. A catalyst layer having a thin thickness may provide improved carbon oxide conversion efficiency at low current densities, but the stability of a carbon oxide reduction reaction may deteriorate as current density increases. In a CORE including a catalyst layer having a thin thickness, carbon oxide reduction efficiency may rapidly decrease over time. Accordingly, there is a need for a CORE which is capable of suppressing flooding, and capable of performing a stable electrode reaction at a high current density, and/or maintaining improved carbon oxide conversion efficiency for a long time.

Provided is a CORE which may have a novel structure to suppress flooding, perform a stable electrode reaction at a high current density, and/or maintain improved carbon oxide conversion efficiency for a long time.

Provided is a carbon oxide electrolyzer cell including a CORE.

Provided is a method of preparing a CORE.

Additional aspects will be set forth in part in the description which follows and, in part, will be apparent from the description, or may be learned by practice of the presented embodiments of the disclosure.

According to an aspect of the disclosure, a CORE includes a GDL including a microporous substrate (MPS) which includes conductive fibers, and a microporous catalyst layer (MPCL) on the GDL. The MPCL includes conductive particles and catalyst particles and has a thickness of 10 micrometers (μm) or more.

According to another aspect of the disclosure, a carbon oxide electrolyzer cell includes the CORE, an oxidation electrode, and an electrolyte disposed between the CODE and the oxidation electrode.

According to another aspect of the disclosure, a method of preparing a CORE includes providing a first stack including an MPS and a microporous layer disposed on the MPS. The MPS contains conductive fibers, and a microporous layer includes conductive particles, coating the microporous layer of the first stack with a composition including a catalyst precursor, optionally, pressing the second stack, wherein the third stack includes a microporous precursor layer which includes conductive particles and a catalyst precursor, and heat-treating the first stack or the third stack to prepare a CORE including an MPCL that includes conductive particles and catalyst particles, and the MPCL has a thickness of 10 μm or more.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic cross-sectional view of a carbon oxide reduction electrode according to the related prior art;

FIG. 2 is a schematic cross-sectional view of a carbon oxide reduction electrode according to an embodiment;

FIG. 3 is a schematic cross-sectional view of a carbon oxide reduction electrode according to an embodiment;

FIG. 4 is a schematic cross-sectional view of a carbon oxide reduction electrode according to an embodiment;

FIG. 5 is a schematic view illustrating an electrolyzer cell according to an embodiment;

FIG. 6 is a schematic view illustrating an H-type electrolyzer cell according to an embodiment;

FIG. 7 is a schematic view illustrating a flow electrolyzer cell according to an embodiment;

FIG. 8 is a schematic view illustrating a membrane electrode assembly (MEA) electrolyzer cell according to an embodiment;

FIG. 9A is a scanning electron microscope image of a cross section of a carbon oxide reduction electrode prepared in Example 1;

FIG. 9B shows an energy dispersive spectroscopy (EDS) analysis result showing a carbon (C) concentration distribution in the cross section of the carbon oxide reduction electrode of FIG. 9A;

FIG. 9C shows an EDS analysis result showing a copper (Cu) concentration distribution in the cross section of the carbon oxide reduction electrode of FIG. 9A;

FIG. 10A shows a scanning electron microscope image of a cross section of a carbon oxide reduction electrode prepared in Comparative Example 1;

FIG. 10B is an EDS analysis result showing a carbon (C) concentration distribution in the cross section of the carbon oxide reduction electrode of FIG. 10A;

FIG. 10C shows an EDS analysis result showing a copper (Cu) concentration distribution in the cross section of the carbon oxide reduction electrode of FIG. 10A;

FIG. 11 is a scanning electron microscope image of a cross section of a carbon oxide reduction electrode prepared in Comparative Example 2;

FIG. 12A shows a water contact angle of the carbon oxide reduction electrode prepared in Example 1, wherein the water contact angle is 133.9 degrees in FIG. 12A;

FIG. 12B shows a water contact angle of the carbon oxide reduction electrode prepared in Comparative Example 1, wherein the water contact angle is 120.6 degrees in FIG. 12B;

FIG. 12C shows a water contact angle for the carbon oxide reduction electrode prepared in Comparative Example 2, wherein the water contact angle is 22.2 degrees in FIG. 12C;

FIG. 13A shows a Raman spectrum according to a reduction current density of a catalyst layer of the carbon oxide reduction electrode prepared in Example 1;

FIG. 13B shows a Raman spectrum according to a reduction current density of a catalyst layer of the carbon oxide reduction electrode prepared in Comparative Example 1;

FIG. 14A shows results of measuring, with respect to carbon oxide and carbon monoxide, an overvoltage according to a current density of the carbon oxide reduction electrode prepared in Example 1;

FIG. 14B shows results of measuring, with respect to carbon oxide and carbon monoxide, an overvoltage according to a current density of the carbon oxide reduction electrode prepared in Comparative Example 1;

FIG. 15A is a graph showing a product distribution and Faradaic efficiency according to a current density of an electrolyzer cell including the carbon oxide reduction electrode of Example 1;

FIG. 15B is a graph showing a product distribution and Faradaic efficiency according to a current density of an electrolyzer cell including the carbon oxide reduction electrode of Comparative Example 1;

FIG. 15C is a graph showing a product distribution and Faradaic efficiency according to a current density of an electrolyzer cell including the carbon oxide reduction electrode of Comparative Example 2;

FIG. 16A is a graph showing a change in faradaic efficiency of a carbon oxide reduction reaction over time at a current density of −400 mA/cm² for the electrolyzer cell including the carbon oxide reduction electrode of Example 1; and

FIG. 16B is a graph showing a change in faradaic efficiency of a carbon oxide reduction reaction over time at a current density of −800 mA/cm² for the electrolyzer cell including the carbon oxide reduction electrode of Example 1.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects.

Unless otherwise defined, all terms (including technical and scientific terms) used in the disclosure have the same meaning as commonly understood by one of ordinary skill in the art to which the disclosure belongs. In addition, it will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

Embodiments are described in the disclosure with reference to cross-sectional views which are schematic diagrams of idealized embodiments, the disclosure As such, variations from the shapes of the illustrations as a result, for example, of manufacturing techniques and/or tolerances, are to be expected. Thus, the embodiments described in the disclosure should not be construed as limited to the particular shapes regions of illustrated in the disclosure but may include deviations in shapes that result, for example, from manufacturing. For example, regions illustrated or described as being flat may be typically rough and/or have nonlinear features. Moreover, sharp-drawn angles may be round. Thus, regions illustrated in the drawings are schematic in nature and their shapes are not intended to illustrate the actual shape of a region and are not intended to limit the scope of the claims.

The present inventive concept may, however, be embodied in different forms and should not be construed as limited to the embodiments described in the disclosure. These embodiments are provided so that the disclosure will be thorough and complete, and will fully convey the scope of the present inventive concept to those skilled in the art. Like reference numerals designate like elements.

When it is described that an element is “on” another element, it will be understood that the element may be disposed directly on another element or still another element may be interposed therebetween. On the other hand, when it is described that an element is “directly on” another element, still another element is not interposed therebetween.

Terms such as “first,” “second,” “third,” and the like may be used in this disclosure to describe various components, components, regions, layers, and/or sections; Layers and/or zones should not be limited by these terms. These terms are only used to distinguish one element, component, region, layer, or section from another region, layer, or section. Thus, a first element, component, region, layer, or section described below may be termed a second element, component, region, layer, or section without departing from the teachings of the disclosure.

The term used in the disclosure is intended to describe only a specific embodiment and is not intended to limit the present inventive concept. As used herein, the singular forms “a,” “an,” and “the” are intended to include the plural forms, including “at least one,” unless the content clearly indicates otherwise. “At least one” should not be construed as being limited to the singular. As used in the disclosure, the term “and/or” includes any and all combinations of one or more of the associated listed items. The terms “includes,” “including,” “comprises,” and/or “comprising,” when used in the detailed description, specify a presence of stated features, regions, integers, steps, operations, elements, and/or components, but do not preclude the presence or addition of one or more other features, regions, integers, steps, operations, elements, components, and/or groups thereof.

Spatially relative terms such as “bottom”, “beneath,” “below,” “lower,” “top”, “above,” and “upper” may be used herein to easily describe one element or feature's relationship to another element or feature. It will be understood that the spatially relative terms are intended to encompass different orientations of a device in use or operation in addition to the orientation illustrated in the drawings. For example, when a device in the drawings is turned over, elements described as “bottom” or “below” or “beneath” other elements or features would then be “top”, “above” or “over” the other elements or features. Thus, the example term “below” may encompass both orientations of above and below. The device may be otherwise oriented (rotated 90 degrees or at other orientations), and the spatially relative terms used in the disclosure may be interpreted accordingly.

In the disclosure, “Group” refers to a group of the periodic table of the elements according to the International Union of Pure and Applied Chemistry (“IUPAC”) Groups 1-18 group classification system.

As used herein, unless otherwise defined, the term “size” of particles refers to the “particle diameter” of particles.

As used herein, the term “particle diameter” of particles refers to a diameter when particles are spherical and refers to a major axis length when particles are non-spherical. A particle diameter of particles may be measured by using a particle size analyzer (PSA). A “particle diameter” of particles is, for example, an “average particle diameter.” An average particle diameter refers to, for example, a median particle diameter (D50). The median particle diameter (D50) is a particle size corresponding to a 50% cumulative volume when a particle size distribution measured through a laser diffraction method is calculated from particles having a smaller particle size. Alternatively, an “average particle diameter” may be measured from a scanning electron microscope (SEM) image or a transmission electron microscope (TEM) image through a manual or software.

A “nanostructure” of particles in the disclosure may be determined, for example, from a SEM or TEM image.

The term “metal” as used herein includes all of metals and metalloids such as silicon and germanium in an elemental or ionic state.

The term “metal” as used herein includes all of metals and metalloids such as silicon and germanium in an elemental or ionic state.

The term “electrolyzer cell” refers to a cell that causes electrochemical oxidation and electrochemical reduction by using electrical energy.

As used herein, a “reduction electrode” and “cathode” refer to an electrode at which electrochemical reduction occurs.

As used herein, an “oxidation electrode” and “anode” refer to an electrode at which electrochemical oxidation occurs.

Hereinafter, a carbon oxide reduction electrode (CORE), a carbon oxide electrolyzer cell including the CORE, and a method of preparing a CORE according to embodiments will be described in more detail.

### CORE

A CORE according to an embodiment may include a gas diffusion layer (GDL) including a microporous substrate (MPS) that includes conductive fibers, and a microporous catalyst layer (MPCL) on the GDL, wherein the MPCL includes conductive particles and catalyst particles. A thickness of the MPCL is 10 μm or more.

The CORE may include the MPCL to provide improved hydrophobicity. The CORE may have improved hydrophobicity so that the flooding of the CORE may be minimized or prevented. The MPCL may include the catalyst particles and the conductive particles with improved hydrophobicity, thereby more effectively suppressing an electrolyte from penetrating into the MPCL. The MPCL may minimize or prevent the flooding of the CORE. The MPCL having improved hydrophobicity may have a thickness of 10 μm or more, thereby more effectively preventing the flooding of the CORE. For example, if the MPCL is too thin, e.g., less than 1 μm, it may be more difficult to minimize or prevent the flooding of the CORE.

Because the CORE includes a MPCL having a thickness of 10 μm or more, a stable electrode reaction may be performed at a high current density. If the MPCL is too thin, an electrode reaction may become unstable as the current density increases.

The CORE may include the MPCL having a thickness of 10 μm or more to maintain improved carbon oxide conversion efficiency for an extended period of time. If the MPCL becomes too thin, flooding may occur, or carbon oxide conversion efficiency may rapidly decrease.

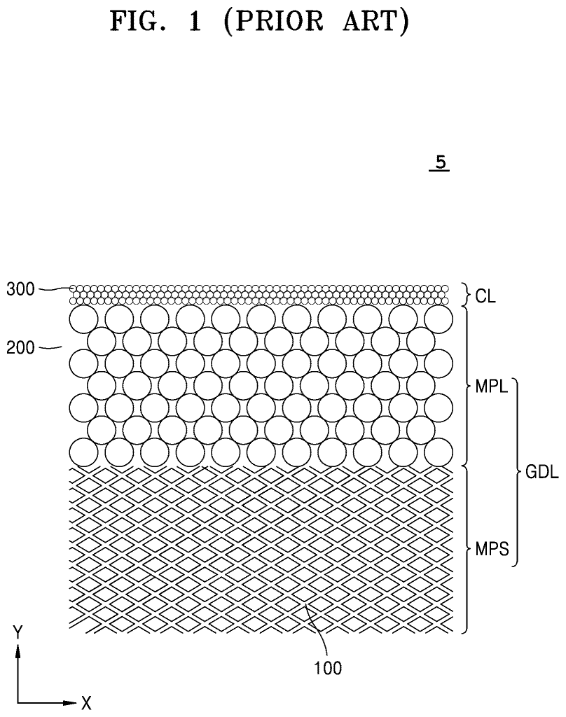

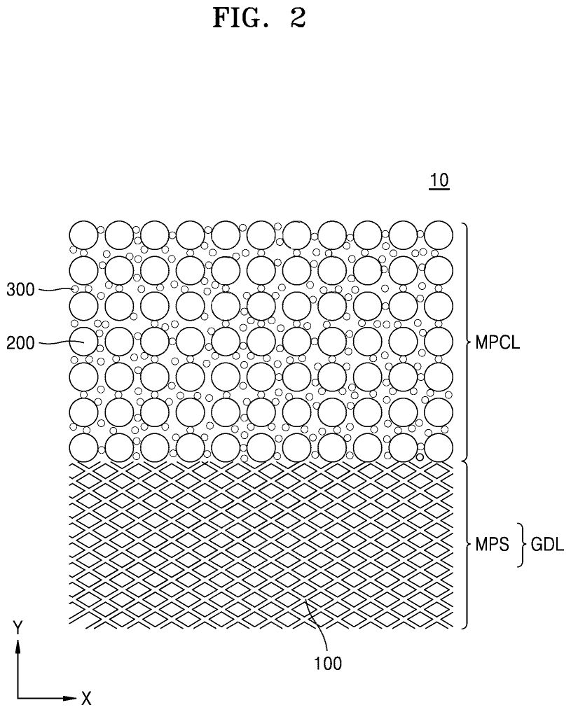

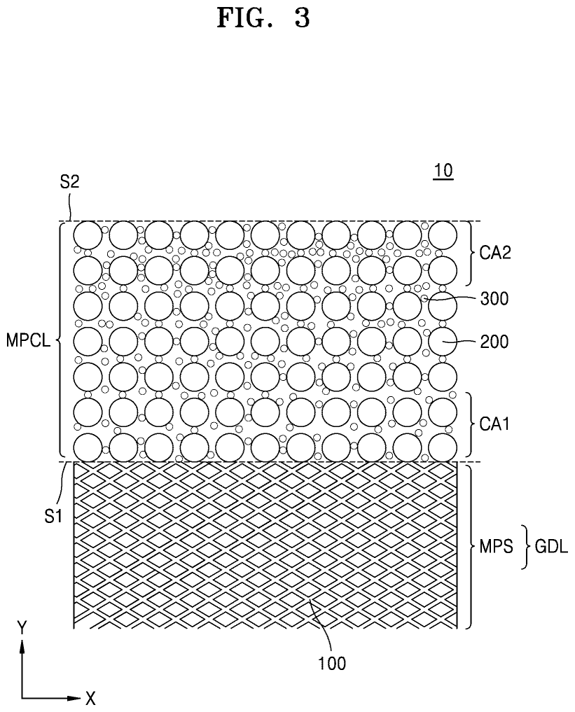

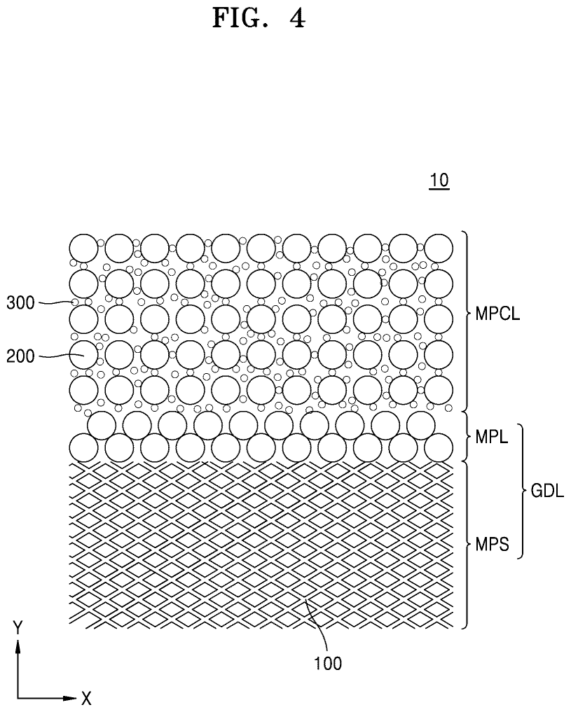

FIG. 1 is a schematic cross-sectional view of a CORE 10 according to a related prior art. FIG. 2 is a schematic cross-sectional view of a CORE 10 according to an embodiment. FIG. 3 is a schematic cross-sectional view of a CORE 10 according to an embodiment. FIG. 4 is a schematic cross-sectional view of a CORE 10 according to an embodiment.

Referring to FIG. 1, the CORE 5 according to the related prior art may include a GDL which includes an MPS including conductive fibers 100, and a microporous layer (MPL), which includes conductive particles 200 that are disposed on the MPS. The CORE may also include a separate catalyst layer CL on the GDL. The catalyst layer CL may include catalyst particles, a binder, and the like, but does not include the conductive particles 200, the conductive fibers 100, or the like. The catalyst layer CL may have a relatively thin thickness, for example, a thickness of less than 1 μm. The catalyst layer CL may have reduced hydrophobicity. The catalyst layer CL may have a thickness to increase the efficiency of a catalytic reaction, but may have reduced hydrophobicity, and thus flooding may likely occur at a high current density. The CORE 10 according to the related art including the catalyst layer CL with reduced hydrophobicity and a thin thickness may easily deteriorate and may have low stability. and thus, offer little or no potential to apply commercially.

Referring to FIGS. 2 to 4, the CORE 10 of an embodiment may include a GDL including an MPS which contains conductive fibers 100. The CORE 10 may include an MPCL disposed on the GDL. The MPCL may include conductive particles 200 and catalyst particles 300. The MPCL may additionally include the conductive particles 200 in addition to the catalyst particles 300, and thus hydrophobicity may be improved. The MPCL may have a thickness of, for example, 10 μm or more, 20 μm or more, 40 μm or more, or 70 μm or more. The MPCL may have a thickness of, for example, 200 μm or less, 170 μm or less, 150 μm or less, or 120 μm or less. The MPCL may have a thickness of, for example, about 10 μm to about 200 μm, about 20 μm to about 170 μm, about 40 μm to about 150 μm, or about 70 μm to about 120 μm. When the MPCL has a thickness in such a range, the flooding of the CORE 10 may be suppressed, and stability may be improved.

Referring to FIGS. 2 to 4, the MPCL may include, for example, a porous structure 400 formed by the conductive particles 200, and the catalyst particles 300 supported on the porous structure. The MPCL may include the porous structure formed by the conductive particles 200 to provide improved hydrophobicity. The porous structure 400 may include, for example, one porous conductive particle 200, an aggregate of a plurality of conductive particles, or a combination thereof. The porous structure may include, for example, three-dimensional frameworks formed by one or more conductive particles 200 and pores disposed between the three-dimensional frameworks. The catalyst particles 300 may be supported, for example, on the three-dimensional framework of the porous structure formed by one or more conductive particles 200. The catalyst particle 300 may be disposed to fill, for example, at least a portion of pores included in a conductive particle 200 or pores spatially created between conductive particles 200. For example, the catalyst particles 300 may be disposed between a plurality of conductive particles 200 to fill, for example, at least some of pores spatially formed by the plurality of conductive particles 200. The MPCL may include the porous structure and the catalyst particles 300 supported thereon to provide both improved hydrophobicity and excellent catalytic activity. Since the MPCL has such a structure, the flooding of the CORE 10 may be more effectively suppressed, and the CORE 10 may stably operate at a high current density.

The MPCL may include pores. A shape of the pores included in the MPCL may be, for example, a spherical shape, a polyhedral shape, or an irregular shape. The pores included in the MPCL may have a size of, for example, 10 nm or more, 100 nm or more, or 200 nm. The pores included in the MPCL may have a size of, for example, 5 μm less, 3 μm or less, or 1 μm or less. The pores included in the MPCL may have a size of, for example, about 10 nm to about 5 μm, about 100 nm to about 5 μm, or about 200 nm to about 1 μm. Because the MPCL has a pore size in such a range, carbon oxides may be smoothly supplied. The pore size of the MPCL is referred to an average pore diameter. For example, equivalent circular diameters of 10 pores measured from a SEM image of a surface or cross section of the MPCL may be measured, and an arithmetic mean value thereof may be calculated to obtain an average pore diameter of pores.

A catalyst particle content measured in inductively coupled plasma spectroscopy (ICP) analysis of the MPCL may be, for example, in a range of about 0.01 parts per million (ppm) to about 100 ppm, about 0.01 ppm to about 50 ppm, about 0.01 ppm to about 30 ppm, about 0.01 ppm to about 20 ppm, about 0.01 ppm to about 10 ppm. In the ICP analysis of the MPCL, the catalyst particle content may be, for example, in a range of about 0.01 ppm to about 4 ppm, about 0.01 ppm to about 2 ppm, or about 0.1 ppm to about 2 ppm. Because the MPCL has a catalyst content in such a range, the flooding of the CORE 10 may be suppressed, and the CORE 10 may be stably operated at a high current density. If the catalyst particle content is too high, the hydrophobicity of the MPCL may decrease, which may make the MPCL more prone to flooding.

A catalyst particle loading amount of the MPCL may be, for example, in a range of about 1 μg/cm² to about 10 mg/cm², about 1 μg/cm² to about 5 mg/cm², about 1 μg/cm² to about 1 mg/cm², or about 1 μg/cm² to about 500 μg/cm². The catalyst loading amount of the MPCL may be, for example, in a range of about 1 μg/cm² to about 200 μg/cm², about 1 μg/cm² to about 150 μg/cm², or about 1 μg/cm² to about 100 μg/cm². Because the MPCL has a catalyst particle loading amount in such a range, the flooding of the CORE 10 may be suppressed, and the CORE 10 may be stably operated at a high current density. If the catalyst loading amount is too high, the hydrophobicity of the MPCL may decrease, which may make the MPCL more prone to flooding. For example, the catalyst particle loading amount of the MPCL may be calculated by dividing a catalyst amount of the MPCL measured through ICP by an area of the MPCL.

The MPCL may characterized in a Raman spectrum with at least one of a D band peak in a range of about 1,320 cm⁻¹ to about 1,440 cm⁻¹ and a G band peak in a range of about 1,480 cm⁻¹ to about 1,580 cm⁻¹. The MPCL may exhibit at least one of a D band peak and a G band peak derived from a carbonaceous material in a Raman spectrum. Because the MPCL includes a peak in a Raman spectrum of a carbonaceous material (G band), the hydrophobicity of the MPCL may be improved. The flooding of the CORE 10 including such an MPCL may be suppressed.

In a Raman spectrum of the MPCL, a peak intensity ratio ID/IG of an intensity ID of a D band peak in a range of about 1,320 cm⁻¹ to about 1,440 cm⁻¹ to an intensity IG of a G band peak in a range of about 1,480 cm⁻¹ to about 1,580 cm⁻¹ may be 2 or less, 1.5 or less, or 1 or less.

In the Raman spectrum of the MPCL, the peak intensity ratio ID/IG of the intensity ID of the D band peak in a range of about 1,320 cm⁻¹ to about 1,440 cm⁻¹ to the intensity IG of the G band peak in a range of about 1,480 cm⁻¹ to about 1,580 cm⁻¹ may be in a range of 0.1 to about 2, about 0.1 to about 1.5, about 0.1 to about 1.0, or about 0.1 to about 0.95. The MPCL may have the peak intensity ratio ID/IG in such a range in the Raman spectrum and thus may have improved hydrophobicity. The flooding of the CORE 10 including such an MPCL may be more effectively prevented.

Referring to FIG. 3, the MPCL may include a first side S1 adjacent to the GDL, and a second side S2 opposite the first side S1. The second side S2 may be, for example, a top surface of the MPCL. The MPCL may include a first area CA1 adjacent (or proximate) to the first side S1 and a second area CA2 adjacent (or proximate) to the second side S2.

A thickness of the first area CA1 and a thickness of the second area CA2 may independently be 1/3 or less, 1/4 or less, 1/5 or less, 1/8 or less, or 1/10 or less of the total thickness of the MPCL. In energy dispersive spectroscopy (EDS) analysis of the cross section of the MPCL, a catalyst particle concentration of the first area CA1 may be lower than a catalyst particle concentration of the second area CA2. In the EDS analysis of the cross section of the MPCL, a ratio CCA1/CCA2 of a catalyst particle concentration CCA1 of the first area CA1 to a catalyst particle concentration CCA2 of the second area CA2 may be, for example, 0.9 or less, 0.7 or less, or 0.5 or less. The MPCL may have such a catalyst particle concentration, and thus catalytic activity in an area adjacent to the first side S1 of the MPCL may be further improved.

Referring to FIG. 3, the MPCL may include the first side S1 adjacent (or proximate) to the GDL, and the second side S2 opposite to the first side S1. The second side may be, for example, the top surface of the MPCL. In the EDS analysis of the cross section of the MPCL, the MPCL may have a catalyst particle concentration gradient in which a concentration decreases in a direction from the second side S2 to the first side S1. For example, in the MPCL, a catalyst particle concentration may gradually decrease in a direction (−y direction) from the second side S2 to the first side S1. That is, in the MPCL, the catalyst particle concentration may gradually increase in a direction (y direction) from the first side S1 to the second side S2. Because the MPCL has such a catalyst particle concentration gradient, catalytic activity may be further improved in an area adjacent to the first side S1.

The MPCL may have a catalyst particle concentration gradient in which a concentration continuously decreases, for example, in a direction from the second side S2 to the first side S1. The MPCL may have the catalyst particle concentration gradient in which the concentration continuously decreases, for example, in a direction from the second side S2 to the first side S1, and thus catalytic activity may be easily adjusted. An area having a catalyst particle concentration gradient in which a concentration continuously decreases in the MPCL may be, for example, a portion or all of the MPCL. For example, the MPCL may have a constant catalyst particle content from the second side S2 to an area of 5/10, 7/10, or 9/10 of the total thickness and may have a catalyst particle concentration gradient in which a concentration continuously decreases in the remaining area of 5/10, 3/10, or 1/10 of the total thickness.

For example, the MPCL may have a catalyst particle concentration gradient in which a concentration stepwise decreases in a direction from the second side S2 to the first side S1. For example, the MPCL may have the catalyst particle concentration gradient in which the concentration stepwise decreases in the direction from the second side S2 to the first side S1, and thus catalytic activity according to a position of the MPCL may be more easily adjusted. An area having a catalyst particle concentration gradient in which a concentration stepwise decreases in the MPCL may be, for example, a portion or all of the MPCL. For example, the MPCL may have a constant catalyst particle content from the second side S2 to an area of 5/10, 7/10, or 9/10 of the total thickness and may have a catalyst particle concentration gradient in which a concentration stepwise decreases in the remaining area of 5/10, 3/10, or 1/10 of the total thickness.

The conductive particles 200 may include, for example, primary particles, secondary particles that are each an aggregate of a plurality of primary particles, or a combination thereof. A diameter of the primary particles of the conductive particles 200 may be, for example, in a range of about 1 nm to about 1 μm, about 5 nm to about 500 nm, about 10 nm to about 400 nm, about 50 nm to about 200 nm, about 50 nm to about 150 nm, or about 50 nm to about 100 nm. The diameter of the primary particles of the conductive particles 200 may be measured from a SEM image of the surface or cross section of the MPCL. Because the primary particles of the conductive particles 200 have a diameter in such a range, both an improvement in hydrophobicity and conductivity may be achieved. The diameter of the primary particles of the conductive particles 200 may be, for example, an average primary particle diameter of the conductive particles 200. For example, equivalent circular diameters of 10 primary particles measured from a SEM image of the surface or cross section of the MPCL may be measured, and an arithmetic mean value thereof may be calculated to obtain the average primary particle diameter of the conductive particles 200.

A shape of the conductive particle 200 may be, for example, a spherical shape such as a sphere or an oval, a plate-like shape, a needle-like shape, an irregular shape, or a combination thereof. An aspect ratio of the conductive particle 200 may be 10 or less, 5 or less, or 3 or less. The aspect ratio of the conductive particle 200 may be a ratio of a major axis which is a maximum distance between two ends of a particle to a minor axis which is perpendicular to the major axis. The aspect ratio of the conductive particle 200 may be determined, for example, from a SEM image. The conductive particles 200 may include, for example, carbon particles. The conductive particles 200 may include, for example, porous carbon particles. The carbon particles may include, for example, amorphous carbon, crystalline carbon, or a combination thereof. The carbon particles may exhibit, for example, at least one of a D band peak in a range of about 1,320 cm⁻¹ to about 1,440 cm⁻¹ and a G band peak in a range of about 1,480 cm⁻¹ to about 1,580 cm⁻¹ in a Raman spectrum. The carbon particles may include, for example, carbon black, graphite, or a combination thereof. Carbon black may include, for example, acetylene black, Ketjen black, super P carbon, channel black, furnace black, lamp black, thermal black, or a combination thereof.

The catalyst particles 300 may include, for example, primary particles, secondary particles that are an aggregate of a plurality of primary particles, or a combination thereof. A diameter of the primary particles of the catalyst particles 300 may be, for example, 500 nm or less, 300 nm or less, 200 nm or less, 100 nm or less, 50 nm or less, or 10 nm or less. The diameter of the primary particles of the catalyst particles 300 may be, for example, in a range of about 0.1 nm to about 100 nm, about 0.1 nm to about 50 nm, about 0.1 nm to about 10 nm, about 1 nm to about 10 nm, or about 5 nm to about 10 nm. When the primary particles of the catalyst particles 300 have a diameter in such a range, an improvement in catalytic efficiency may be achieved. The diameter of the primary particles of the catalyst particles 300 may be measured from a SEM image of the surface or cross section of the MPCL. The diameter of the primary particles of the catalyst particles 300 may be, for example, an average primary particle diameter of the catalyst particles 300. For example, equivalent circular diameters of 10 primary particles measured from a SEM image of the surface or cross section of the MPCL may be measured, and an arithmetic mean value thereof may be calculated to obtain the average primary particle diameter of the catalyst particles 300.

The catalyst particles 300 may include, for example, metal particles selected from Cu, Ag, Ni, Zn, Ba, Sr, Ca, Mg, Zr, Ti, Au, B, Al, In, and Sn, metal oxide particles containing the metal, metal hydroxide particles containing the metal, or a combination thereof. The metal oxide particles may include, for example, CuₓO (0<x≤2), Ag₂Oₓ (0<x≤2), NiOₓ (0<x≤2), ZnOₓ (0<x≤2), BaOₓ (0<x≤1), SrOₓ (0<x≤1), CaOₓ (0<x≤1), MgOₓ (0<x≤1), ZrOₓ (0<x≤2), TiOₓ (0<x≤2), Ag₂Oₓ (0<x≤1), Au₂Oₓ (0<x≤3), B₂Oₓ (0<x≤3), Al₂Oₓ (0<x≤3), In₂Oₓ (0<x≤3), SnOₓ (0<x≤2), or a combination thereof. The metal hydroxide particles may include, for example, Cu(OH)_{y} (0<y≤2), Ba(OH)_{y} (0<y≤2), Sr(OH)_{y} (0<y≤2), Ca(OH)_{y} (0<y≤2), Mg(OH)_{y} (0<y≤2), Zr(OH)_{y} (0<y≤4), Ti(OH)_{y} (0<y≤4), Ag(OH)_{y} (0<y≤1), Au(OH)_{y} (0<y≤3), B(OH)_{y} (0<y≤3), Al(OH)_{y} (0<y≤3), In(OH)_{y} (0<y≤3), Sn(OH)_{y} (0<y≤4), or a combination thereof. The catalyst particles 300 may provide improved carbon oxide conversion efficiency.

The catalyst particles 300 may include, for example, copper particles. The copper particles may include, for example, Cu, Cu₂O, CuO, Cu(OH)₂, or a combination thereof. The catalyst particles 300 may include these copper particles to provide improved carbon oxide conversion efficiency.

The primary particle diameter of the catalyst particles 300 may be smaller than, for example, the primary particle diameter of the conductive particles 200. The primary particle diameter of the catalyst particles 300 may be, for example, 90% or less, 80% or less, 50% or less, 30% or less, or 10% or less of the primary particle diameter of the conductive particles 200. The primary particle diameter of the catalyst particles 300 may be, for example, in a range of about 0.1% to about 90%, about 1% to about 80%, about 1% to about 50%, about 1% to about 30%, or about 1% to about 10%, of the primary particle diameter of the conductive particles 200. Because the primary particle diameter of the catalyst particle 300 has such a range as compared to the primary particle diameter of the conductive particle 200, the catalyst particles 300 may be supported on the conductive particles 200 or the porous structure formed by the conductive particles 200.

Referring to FIG. 4, the GDL may further include, for example, an MPL. The MPL may be disposed between the MPS and the MPCL. The MPL may include, for example, carbon particles. The carbon particles of the MPL may be selected from carbon particles used in, for example, the MPCL. The MPL may not include, for example, the catalyst particles 300. Since the MPL does not include the catalyst particles 300, the MPL may constitute a portion of the GDL. The GDL may include the MPL, and thus the flooding of the GDL may be more effectively minimized or prevented.

Referring to FIGS. 1 to 4, the MPS may include the conductive fibers 100. The conductive fiber 100 may include, for example, carbon fiber, metal fiber, or a combination thereof. The metal fiber may be, for example, titanium fiber. The carbon fiber may be, for example, graphite fiber. A diameter of the conductive fiber 100 may be, for example, 30 μm or less, 20 μm or less, or 10 μm or less. A length of the conductive fiber 100 may be, for example, 1 mm or more, 5 mm or more, or 10 mm or more. Because the conductive fiber 100 has a diameter and/or length in such a range, the conductive fiber 100 may provide excellent structural stability.

The MPS may have a thickness of, for example, 250 μm or less, 200 μm or less, or 150 μm or less. The MPS may have a thickness of, for example, about 100 μm to about 250 μm, about 100 μm to about 200 μm, or about 100 μm to about 150 μm. Because the MPS has a thickness in such a range, the MPS may provide both improved structural stability and flexibility.

The MPS may have a porosity of, for example, about 60 vol % to about 95 vol %, about 70 vol % to about 90 vol %, or about 80 vol % to about 90 vol %. Since the MPS has porosity in such a range, carbon oxide diffusion through the MPS may more readily proceed.

A density of the MPS may be, for example, in a range of about 0.1 g/cm³ to about 1 g/cm³, about 0.1 g/cm³ to about 0.5 g/cm³, or about 0.2 g/cm³ to about 0.5 g/cm³. Because the MPS has a density in such a range, an energy density per unit volume of a carbon oxide battery cell may be improved.

At least one of the MPS and the MPCL may include a hydrophobic binder. Because the MPS and the MPCL include the hydrophobic binder, the flooding of the CORE 10 may be effectively minimized or prevented. The hydrophobic binder may include, for example, a fluorine-based binder. The fluorine-based binder may include, for example, polytetrafluoroethylene (PTFE), polytetrafluoroethylene-hexafluoroethylene, polyvinylidene fluoride, or a combination thereof. A content of the hydrophobic binder may be 20 wt % or less, 10 wt % or less, or 5 wt % or less with respect to the total weight of the MPS and the MPCL. However, if the content of the hydrophobic binder is too much the internal resistance of the MPS and/or the MPCL may increase.

The MPCL may further include, for example, an ion-conductive binder. The ion-conductive binder may be, for example, an ionomer such as Nafion. The ion-conductive binder may provide a binding force and/or ionic conductivity. A content of the ion-conductive binder may be, for example, 20 wt % or less, 10 wt % or less, or 5 wt % or less of the total weight of the MPCL. The ion-conductive binder may be omitted.

A contact angle of the MPCL with respect to distilled water measured at a temperature of 25° C. and a pressure of 1 atm through a Sessil drop method may be, for example, 130 degrees or more, 131 degrees or more, or 133 degrees or more. Because the MPCL has a high contact angle of 130 degrees or more, the MPCL may have improved hydrophobicity. The flooding of the MPCL may be effectively minimized or prevented.

The Gurley gas permeability of a CORE may be, for example, 5 seconds or less, 3 seconds or less, or 1 second or less. Because the CORE has Gurley gas permeability in such a range, carbon oxide gas may be readily supplied to the MPCL.

### Carbon Oxide Electrolyzer Cell

A carbon oxide electrolyzer cell according to another embodiment may include the above-described CORE 10 which converts carbon oxide into a multi-carbon compound, an oxidation electrode, and an electrolyte disposed between the CORE 10 and the oxidation electrode. Because the carbon oxide electrolyzer cell includes the CORE 10 described above, flooding may be suppressed, a stable electrode reaction may be performed at a relatively high current density, and improved carbon oxide conversion efficiency may be maintained over extended periods of time.

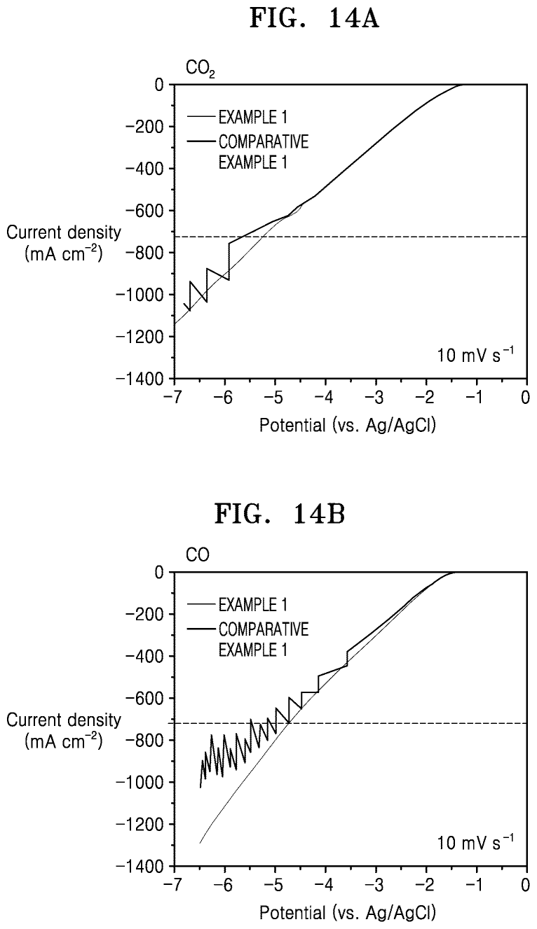

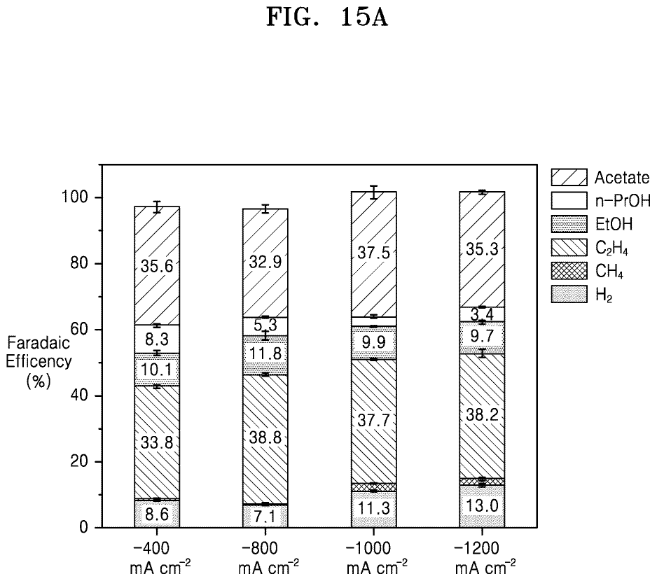

The carbon oxide electrolyzer cell may have a linear relationship between a current density and a voltage at a current density of −700 mA/cm² or more when a carbon dioxide reduction current is measured through linear sweep voltammetry (LSV) at a scan rate of 10 mV/s. For example, at a current density of −700 mA/cm² or more, a current density according to a voltage may have a gradient in the form of a first-order function. For example, reference may be made to Example 1 of FIGS. 14A and 14B.

The carbon oxide electrolyzer cell may have a linear relationship between a current density and a voltage at a current density of about −700 mA/cm² to about −1,200 mA/cm² about −700 mA/cm² to about −1,100 mA/cm², or about −700 mA/cm² to about −1,000 mA/cm², at a carbon dioxide reduction current is determined by LSV at a scan rate of 10 mV/s. The carbon oxide electrolyzer cell may stably operate at a high current density of −700 mA/cm² or more.

In a carbon oxide electrolyte, after 20 hours of operation, faradaic efficiency of a reaction for obtaining ethylene from carbon dioxide may be 80% or more or 85% or more of initial faradaic efficiency. In the carbon oxide electrolyte, after 20 hours of operation, faradaic efficiency of a reaction for obtaining ethylene from carbon dioxide may be maintained to be 80% or more of initial faradaic efficiency, and thus a stably operation may be performed for an extended period of time.

FIG. 5 is a schematic view of a multi-carbon compound electrolyzer cell 1 according to an embodiment. Referring to FIG. 5, the multi-carbon compound electrolyzer cell 1 may include a CORE 10, an oxidation electrode 20, and an electrolyte 30 disposed between the CORE 10 and the oxidation electrode 20. Electrical energy may be supplied between the CORE 10 and the oxidation electrode 20.

Carbon dioxide may be supplied to the CORE 10, and a multi-carbon compound which is a reduction product of carbon dioxide may be discharged from the CORE 10. Since the CORE 10 comes into contact with carbon dioxide which is a fuel, the CORE 10 may be a fuel electrode. Since a reduction reaction occurs, the CORE 10 may be a cathode.

Water may be supplied to the oxidation electrode 20, and oxygen may be discharged from the oxidation electrode 20. Since the oxidation electrode 20 comes into contact with oxygen, the oxidation electrode 20 may be an oxygen electrode. Because an oxidation reaction occurs, the oxidation electrode 20 may be an anode.

The electrolyte 30 may be a cation-conductive electrolyte or an anion-conductive electrolyte. A cation may be, for example, a proton. An anion may be, for example, a hydroxyl ion. The electrolyte 30 may be a liquid electrolyte, a solid electrolyte, a gel electrolyte, or a combination thereof.

As shown in the Reaction Formulas below, an electrochemical reaction of the multi-carbon compound electrolyzer cell 1 may include a reduction reaction in which carbon dioxide (CO₂) is converted into a multi-carbon compound (for example, C₂H₄) and a hydroxyl ion (OH⁻) at the CORE 10, and an oxygen evolution reaction (OER) in which a hydroxyl ion diffusing through the electrolyte 30 is converted into oxygen gas (O₂). The OER may be, for example, an oxidation reaction. The following reaction may be performed using an anion-conductive electrolyte.

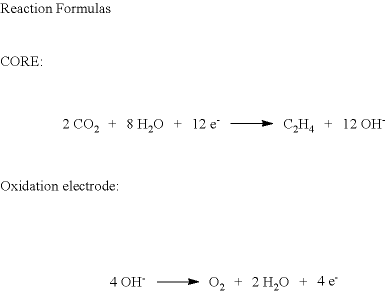

A whole reaction in which carbon dioxide is converted into a multi-carbon compound may be expressed as follows:

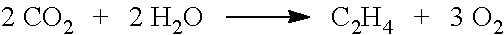

When electrical energy is supplied an external power source to the multi-carbon compound electrolyzer cell 1, electrons may be supplied to the multi-carbon compound electrolyzer cell 1 from the external power source.

Electrons may react with carbon oxide supplied to the CORE 10 to generate a multi-carbon compound and a hydroxy ion. Multi-carbon compound (for example, ethylene) gas may be discharged to the outside, and the hydroxy ion may pass through the electrolyte 30 (for example, anion-conductive electrolyte) to move to the oxidation electrode 20. The hydroxy ion that has moved to the oxidation electrode 20 may lose electrons and may be converted into water and oxygen and discharged to the outside.

Although not shown in the drawings, a gas supply channel may be disposed on one side of the CORE 10, and a gas supply channel may be disposed on one side of the oxidation electrode 20.

The electrolyte 30 of the multi-carbon compound electrolyzer cell 1 may include, for example, a liquid electrolyte, a solid electrolyte, a gel electrolyte, or a combination thereof.

The liquid electrolyte may be, for example, an acidic solution or a basic solution. The liquid electrolyte may be, for example, an aqueous solution. The liquid electrolyte may be an acidic solution including, for example, a hydrochloric acid, a sulfuric acid, a nitric acid, or the like. The liquid electrolyte may be a basic solution including, for example, NaOH, KOH, or the like.

The solid electrolyte may include, for example, a cation-conductive polymer, a cation-conductive solid oxide, an anion-conductive polymer, an anion-conductive solid oxide, or the like. The anion-conductive polymer may include, for example, a Sustainion® anion exchange membrane (AEM), Nafion, Fumasep FAPQ-375, AMI-7001, polybenziimidazole (PBI), Neosepta ACN, or the like.

The gel electrolyte may include, for example, a cation-conductive polymer, an anion-conductive polymer, a mixture of a cation-conductive polymer and a liquid electrolyte, a mixture of an anion-conductive polymer and a liquid electrolyte, or the like.

The multi-carbon compound electrolyzer cell 1 may be, for example, an H-type cell, a flow cell, or a membrane electrode assembly (MEA) cell.

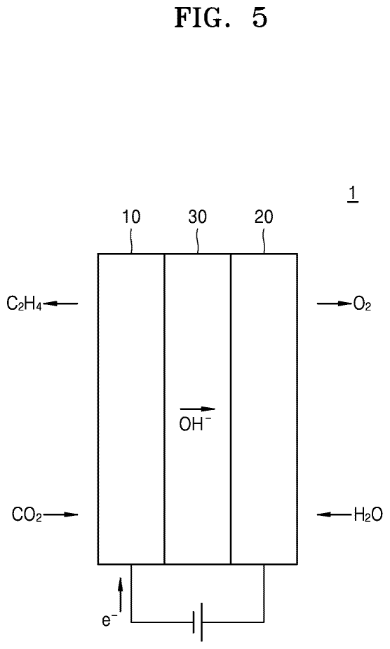

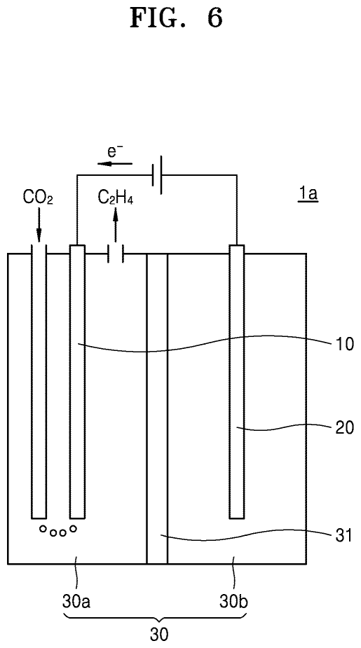

FIG. 6 is a schematic view illustrating an H-type multi-carbon compound electrolyzer cell according to an embodiment. Referring to FIG. 6, an H-type cell 1a may be divided into a carbon oxide reduction electrode chamber including a carbon oxide reduction electrode electrolyte (catholyte) 30a and an oxidation electrode chamber including an oxidation electrode electrolyte (anolyte) 30b by an ion exchange membrane (IEM) 31. The carbon oxide reduction electrode chamber may include a working electrode (WE) 10. The WE 10 may be a CORE. The oxidation electrode chamber may include a counter electrode (CE) 20. The CE 20 may be an oxidation electrode. Carbon dioxide may be continuously supplied to the carbon oxide reduction electrode electrolyte 30a, and for a carbon dioxide reduction reaction, carbon dioxide may be transferred to a surface of the WE 10 through diffusion in the carbon oxide reduction electrode electrolyte 30a. The H-type cell 1a may have a simple structure and may be easy to operate, and thus, may be widely used for testing electrochemical catalysts for a carbon dioxide reduction reaction.

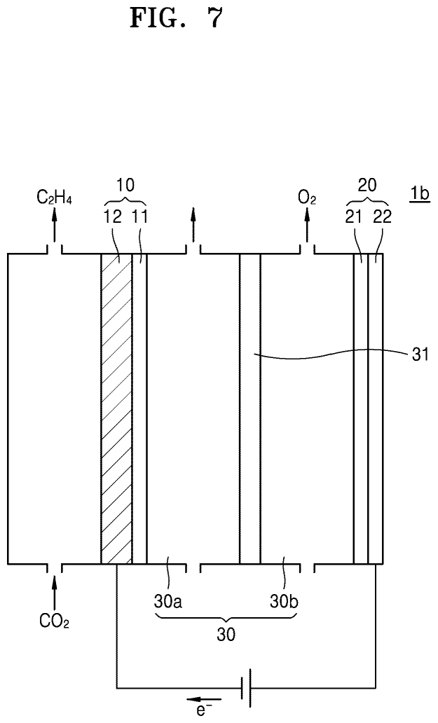

FIG. 7 is a schematic view illustrating a flow cell 1b according to an embodiment. Referring to FIG. 7, the flow cell 1b may include a carbon oxide reduction electrode chamber including a CORE 10, an oxidation electrode chamber including an oxidation electrode 20, and an IEM 31 disposed between the CORE 10 and the oxidation electrode 20. The CORE 10 may include a carbon oxide reduction electrode catalyst layer 11 and a GDL12. The oxidation electrode 20 may include an oxidation electrode catalyst layer 21 and a substrate 22. The carbon oxide reduction electrode electrolyte 30a may be continuously supplied between the CORE 10 and the IEM 31. An oxidation electrode electrolyte 30b may be continuously supplied between the oxidation electrode 20 and the IEM 31. In the flow cell 1b, because carbon oxide is supplied to the carbon oxide reduction electrode catalyst layer 11 through the GDL12 of the CORE 10, a mass transfer of carbon dioxide may be significantly improved as compared to an H-type cell, and a concentration of carbon dioxide may be increased in the CORE 10. In the flow cell 1b, because a distance between the CORE 10 and the oxidation electrode 20 is relatively decreased as compared to an H-type cell, battery resistance may be reduced. Therefore, the reversibility of an electrode reaction may be improved. As a result, the current density and performance of a carbon dioxide reduction reaction may be improved. In the flow cell 1b, because carbon dioxide, the carbon oxide reduction electrode electrolyte 30a, and the oxidation electrode electrolyte 30b are continuously supplied, a carbon dioxide reduction reaction may proceed continuously, thereby improving reaction efficiency.

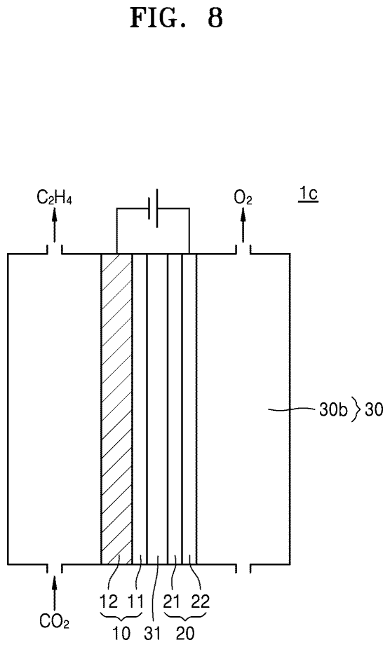

FIG. 8 is a schematic view illustrating an MEA cell 1c according to an embodiment. Referring to FIG. 8, the MEA cell 1c may include a carbon oxide reduction electrode chamber including a CORE 10, an oxidation electrode chamber including an oxidation electrode 20, and an IEM 31 disposed between the CORE 10 and the oxidation electrode 20. The CORE 10 and the IEM 31 may be in direct contact with each other.

The CORE 10 may include a carbon oxide reduction electrode catalyst layer 11 and a GDL12. The oxidation electrode 20 may include an oxidation electrode catalyst layer 21 and a porous substrate 22. Since there is no gap between the GDL12, the carbon oxide reduction electrode catalyst layer 11, and the IEM 31 in the MEA cell 1c, the overflow of an electrolyte may be prevented as compared to the flow cell 1b, and because a carbon oxide reduction electrode electrolyte is excluded, battery resistance may be further reduced, and/or the reversibility of an electrode reaction may be improved. As a result, the current density and performance of a carbon dioxide reduction reaction may be further improved. In the MEA cell 1c, because carbon dioxide and the oxidation electrode electrolyte 30b are continuously supplied, a carbon dioxide reduction reaction may proceed continuously, thereby improving reaction efficiency.

### Method of Preparing CORE

A method of preparing a CORE according to an embodiment may include providing a first stack including an MPS and an MPL disposed on the MPS, wherein the MPS contains conductive fibers, and the MPS includes conductive particles, coating the MPL of the first stack with a composition including a catalyst precursor to provide a second stack, pressing the second stack to provide a third stack, wherein the third stack includes a microporous precursor layer which includes conductive particles and a catalyst precursor, and heat-treating the third stack to provide the CORE including an MPCL that includes conductive particles and catalyst particles. A thickness of the MPCL may be 10 μm or more. The CORE prepared in this way may suppress or minimize flooding, may perform a stable electrode reaction at a high current density, and may maintain improved carbon oxide conversion efficiency over an extended period of time.

The first stack, which includes the MPS containing the conductive fiber and the MPL including the conductive particles is disposed on the MPS. The first stack may include an MPS formed, for example, by conductive fiber. The conductive fiber may include, for example, carbon fiber, metal fiber, or a combination thereof. The MPS may further include a hydrophobic binder such as PTFE. The MPS may be, for example, carbon paper formed by carbon fiber. The carbon fiber may be selected from carbon fibers used in the CORE described above. The MPL including the conductive particles may be disposed on the MPS. The MPL may be prepared, for example, by coating an MPS with an MPL-forming composition, which includes carbon particles, a hydrophobic binder, and a solvent, and drying the MPS. The MPL may include a porous structure formed by carbon particles. The hydrophobic binder may include, for example, a fluorine-based binder. The hydrophobic binder may be, for example, PTFE. The carbon particles may be selected from carbon particles used in the CORE described above. The first stack may be, for example, carbon paper including an MPS formed by carbon particles on an MPS formed by carbon fiber. The carbon paper is not particularly limited, and any carbon paper may be used as long as the carbon paper may have a stack structure including a conductive carbon fiber layer and a conductive carbon particle layer.

The second stack may be prepared by coating the MPL of the first stack with the composition including the catalyst precursor.

The composition including the catalyst precursor may be prepared by mixing a catalyst precursor and a solvent. The catalyst precursor may be a compound including at least one metal selected from Cu, Ag, Ni, Zn, Ba, Sr, Ca, Mg, Zr, Ti, Au, B, Al, In, or Sn. The catalyst precursor may be a salt compound or an organometallic compound including at least one metal selected from Cu, Ag, Ni, Zn, Ba, Sr, Ca, Mg, Zr, Ti, Au, B, Al, In, or Sn. The catalyst precursor may include copper (II) formate tetrahydrate, silver (I) acetate, nickel (II) formate dehydrate, manganese (II) acetate, or the like, but one or more embodiments are not limited thereto. The solvent may include distilled water, methanol, octylamine, 2-amino-2-methyl-1-propanol (AMP), or the like, but one or more embodiments are not limited thereto. The composition including the catalyst precursor may be prepared by mixing and stirring a catalyst precursor and a solvent at room temperature. A mixing and stirring temperature may be adjusted according to types of catalyst precursors. Coating using the composition including the catalyst precursor may be performed, for example, by using a doctor blade (DB), but one or more embodiments are not limited to such a method. Any method may be used as long as a catalyst precursor composition may be applied.

Next, the second stack may be pressed to prepare the third stack including the microporous precursor layer which includes the conductive particles and the catalyst precursor. Note the pressing step is optional, since n some instances, the step of coating may also include a process in which the coating is applied with pressure.

The pressing may be performed, for example, by using a DB. While the MPL of the first stack is coated with the composition including the catalyst precursor by using the DB, the pressing may be simultaneously performed. A pressing means is not limited to the DB, and any means may be used as long as the means may be used in the art. Through the pressing, the catalyst precursor may be injected into the MPL, thereby forming the microporous precursor layer. The microporous precursor layer may include the porous structure 400 formed by conductive particles, and the catalyst precursor may be supported on the porous structure. An additional operation of removing a solvent from the third stack may be conducted. Any solvent remaining in the microporous precursor layer may be additionally removed under vacuum through an evaporator or the like.

Next, the third stack may be heat-treated to prepare the CORE including the MPCL that includes the conductive particles and the catalytic particles.

A temperature for heat-treating the third stack may be, for example, in a range of about 150° C. to about 400° C., about 150° C. to about 300° C., or about 150° C. to about 250° C. By heat-treating the third layer, the catalyst precursor may be reduced to form catalyst particles. The catalytic particles may include metal particles selected from Cu, Ag, Ni, Zn, Ba, Sr, Ca, Mg, Zr, Ti, Au, B, Al, In, and Sn, metal oxide particles containing a metal selected from Cu, Ag, Ni, Zn, Ba, Sr, Ca, Mg, Zr, Ti, Au, B, Al, In, and Sn, metal hydroxide particles containing a metal selected from Cu, Ag, Ni, Zn, Ba, Sr, Ca, Mg, Zr, Ti, Au, B, Al, In, and Sn, or a combination thereof. The MPL may include the porous structure formed by conductive particles, and the catalyst particles may be supported on the porous structure. The porous structure may be, for example, a three-dimensional structure. The catalyst particles may be distributed throughout the MPCL. A thickness of the MPCL may be, for example, 10 μm or more.

Hereinafter, the disclosure will be described in more detail with reference to the following Examples and Comparative Examples. However, Examples are for illustrative purposes only and are not intended to limit the scope of the disclosure.

### Manufacturing of CORE and Electrolyzer Cell

### Example 1: Cu Catalyst, DB Coating

### (Preparation of CORE (Cathode))

32 mmol of 2-amino-2-methyl-1-propanol (AMP) and 8 mmol of copper (II) formate tetrahydrate were added to 7.5 mL of methanol and stirred at 400 rpm for 30 minutes to prepare a mixed solution. Methanol was removed from the mixed solution by using a rotary vacuum evaporator to prepare a catalyst precursor ink.

Carbon paper (SGL GDL 39BB manufactured by CNL Energy) with a size of 2.5 cm×2.5 cm was prepared as a support. The carbon paper had a two-layer structure of an MPS and an MPL. A thickness of the carbon paper was about 315 μm, and a thickness of the MPL was about 100 μm. The catalyst precursor ink was applied onto the MPL of the carbon paper and pressed by using a DB to allow the catalyst precursor ink to penetrate into the MPL, thereby providing a catalyst precursor-containing carbon paper.

The catalyst precursor-containing carbon paper was heat-treated at a temperature of 205° C. for 5 minutes to prepare a CORE including an MPCL in which catalyst particles are dispersed in an MPL. The MPL included conductive particles and catalytic particles. An MPL substrate corresponds to a GDL.

### (Oxidation Electrode (Anode))

Iridium (IV) oxide (IrO2, 99.9%, manufactured by Alfa Aesar) was used as an OER catalyst. 30 mg of iridium (IV) oxide, 1 ml of isopropanol, and 300 μl of a Nafion solution were mixed and then ultrasonically stirred in a sonicator for 30 minutes to prepare an oxidation electrode catalyst ink. An oxidation electrode was prepared by spraying the oxidation electrode catalyst ink onto a platinized titanium screen mesh (Ti—Pt mesh, 0.002 inch, 9 cm², manufactured by FuelCellStore) by using a spray gun.

### (Manufacturing of Carbon Oxide Electrolyzer Cell)

An AEM (Sustainion X37-50 grade RT membrane manufactured by Dioxide Materials) was immersed in a 1 M KOH solution for 48 hours to exchange the Cl— ions with OH— ions, washed with an excessive amount of distilled water, and then was activated. A carbon oxide electrolyzer cell, which included a gas chamber, a catholyte chamber, and an anolyte chamber in this stated order, was prepared, Carbon oxide was supplied to the gas chamber, a cathode electrolyte was supplied to the catholyte chamber, and an anode electrolyte was supplied to the anolyte chamber. The carbon oxide electrolyzer cell is, for example, a flow cell having the structure of FIG. 7. A cathode was disposed between the gas chamber and the catholyte chamber, and the AEM was disposed between the catholyte chamber and the anolyte chamber. An anode was disposed on the opposite side of the anolyte chamber. An MPCL of the cathode was disposed adjacent to the cathode chamber, and a GDL of the cathode was disposed adjacent to the gas chamber. A mass flow controller (MFC) was connected to the gas chamber to supply carbon oxide gas at a flow rate of 20 sccm. A 1.0 M KOH electrolyte was supplied to each of the catholyte chamber and the anolyte chamber at a flow rate of 20 ml/min. An area of the AEM was 5 cm².

### Example 2: Ag Catalyst, DB Coating, Octylamine Addition

A CORE and an electrolyzer cell were manufactured in the same manner as in Example 1, except that 32 mmol of octylamine, 32 mmol of AMP, and 32 mmol of copper (II) formate tetrahydrate were added to 7.5 mL of methanol to prepare a mixed solution.

### Example 3: Ag Catalyst, DB Coating

A CORE and an electrolyzer cell were manufactured in the same manner as in Example 1, except that 40 mmol of AMP and 20 mmol of silver (I) acetate were added to 7.5 mL of methanol to prepare acetate a mixed solution.

### Example 4: Ni Catalyst, DB Coating

A CORE and an electrolyzer cell were manufactured in the same manner as in Example 1, except that 32 mmol of AMP and 8 mmol of nickel (II) formate dehydrate were added to 7.5 mL of methanol to prepare a mixed solution.

### Example 5: Mn Catalyst, DB Coating

A CORE and an electrolyzer cell were manufactured in the same manner as in Example 1, except that 32 mmol of AMP and 8 mmol of manganese (II) acetate were added to 7.5 mL of methanol to prepare the mixed solution.

### Comparative Example 1: Cu Catalyst, Spray Coating (I)

Catalyst precursor ink was prepared in the same manner as in Example 1.

The catalyst precursor ink was applied onto an MPL of carbon paper by using a spray gun. The Carbon paper coated with a catalyst precursor was heat-treated at a temperature of 205° C. for 5 minutes to prepare a CORE having a catalyst layer formed on the MPL of the carbon paper. A carbon oxide electrolyte was prepared in the same manner as in Example 1.

### Comparative Example 2: Cu Catalyst, Sputtering

A CORE and an electrolyzer cell were manufactured in the same manner as in Example 1, except that a 300 nm thick copper layer was deposited on an MPL of carbon paper through sputtering.

### Evaluation Example 1: SEM-EDS Evaluation

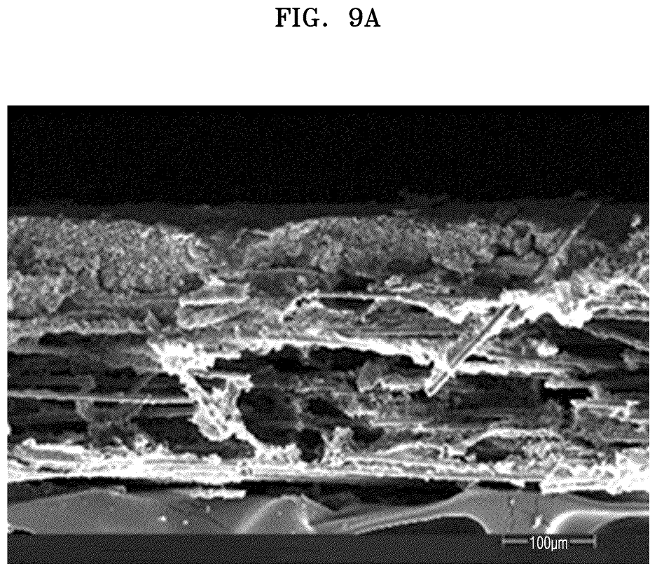

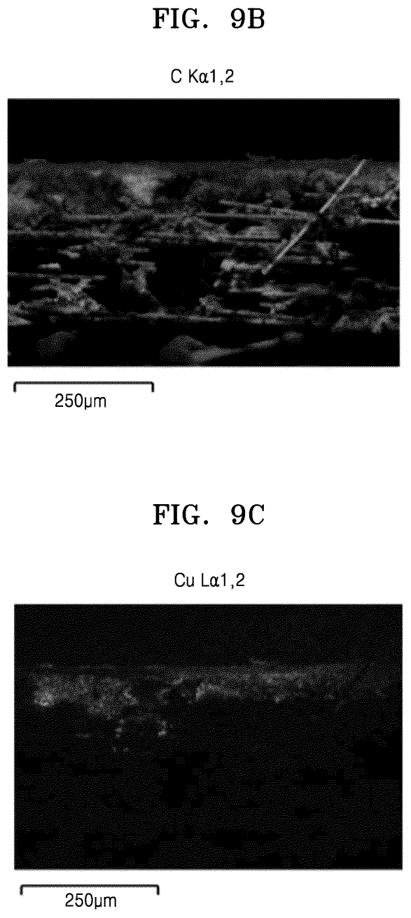

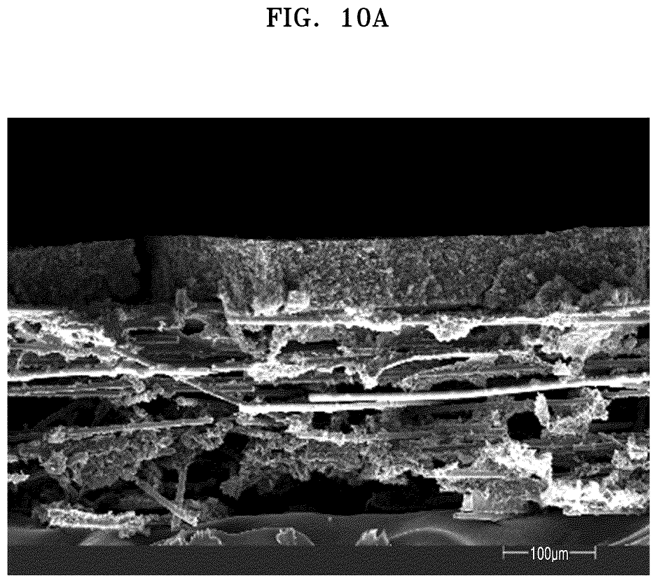

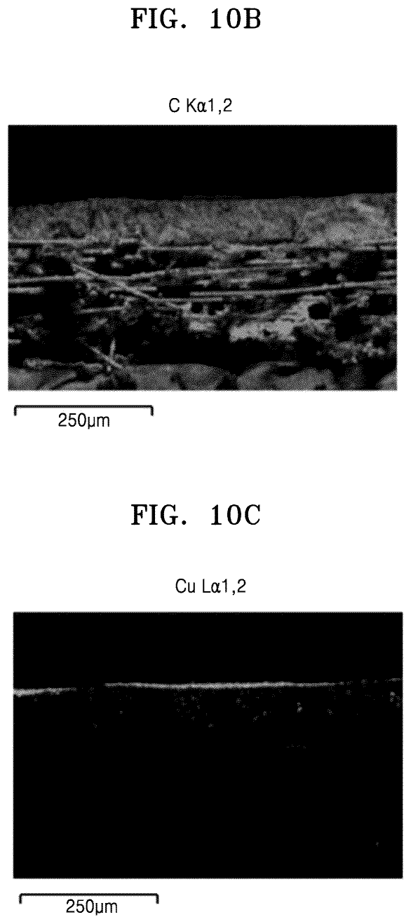

A thickness of a catalyst layer was measured through scanning electron microscopy-energy dispersive spectroscopy (SEM-EDS) analysis of a cross section of each of the COREs prepared in Example 1, Comparative Example 1, and Comparative Example 2. Measurement results are shown in FIGS. 9A to 10C and Table 1 below.

FIG. 9A is a SEM image of a cross section of the CORE prepared in Example 1.

FIG. 9B shows an EDS analysis result showing a carbon (C) concentration distribution in the cross section of the CORE of FIG. 9A.

FIG. 9C shows an EDS analysis result showing a copper (Cu) concentration distribution in the cross section of the CORE of FIG. 9A.

FIG. 10A shows a SEM image of a cross section of the CORE prepared in Comparative Example 1.

FIG. 10B is an EDS analysis result showing a carbon (C) concentration distribution in the cross section of the CORE of FIG. 10A.

FIG. 10C shows an EDS analysis result showing a copper (Cu) concentration distribution in the cross section of the CORE of FIG. 10A.

FIG. 11 is a SEM image of a cross section of the CORE prepared in Comparative Example 2.

As shown in FIGS. 9B and 9C, it was confirmed that carbon was present in the entire area of the CORE prepared in Example 1, and carbon and copper were present in the catalyst layer. The thickness of the catalyst layer including carbon particles and copper particles in the CORE prepared in Example 1 was about 100 μm.

As shown in FIG. 9C, a copper concentration of an area adjacent to an upper end of the catalyst layer was higher than a copper concentration of a lower area adjacent to an MPS. Accordingly, as shown in FIG. 9C, the catalyst layer exhibited a concentration gradient in which a copper concentration gradually and continuously decreased from the area adjacent to the upper end of the catalyst layer to the lower area adjacent to the MPS.

As shown in FIGS. 10B and 10C, it was confirmed that carbon was present in an area of a GDL of the CORE prepared in Example 2, and copper was present in the catalyst layer. The thickness of the catalyst layer of the CORE prepared in Comparative Example 1 was about 1 μm.

Although not shown in the drawings, a thickness of a catalyst layer of the CORE prepared through sputtering in Comparative Example 2 was about 0.3 μm.

TABLE 1

| | Thickness of |
|---|---|
| | catalyst layer (μm) |
| Example 1 (Cu, DB coating) | 90 |
| Comparative Example 1 (Cu, spray coating) | 1 |
| Comparative Example 2 (Cu, sputtering) | 0.3 |

As shown in Table 1, the thickness of the catalyst layer in Example 1 was 10 μm or more, but the thickness of each of the catalyst layers of Comparative Examples 1 and 2 was less than 10 μm.

### Evaluation Example 2: Contact Angle Measurement

A water contact angle of a surface of each of the COREs prepared in Example 1, Comparative Example 1, and Comparative Example 2 was measured. Measurement results are shown in FIGS. 4A to 4C. The water contact angle was measured at a temperature of 25° C. and a pressure of 1 atm by using a Sessil drop method.

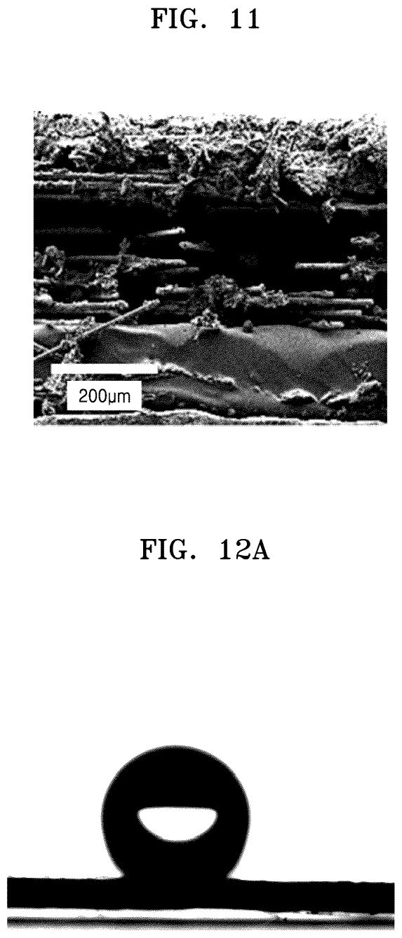

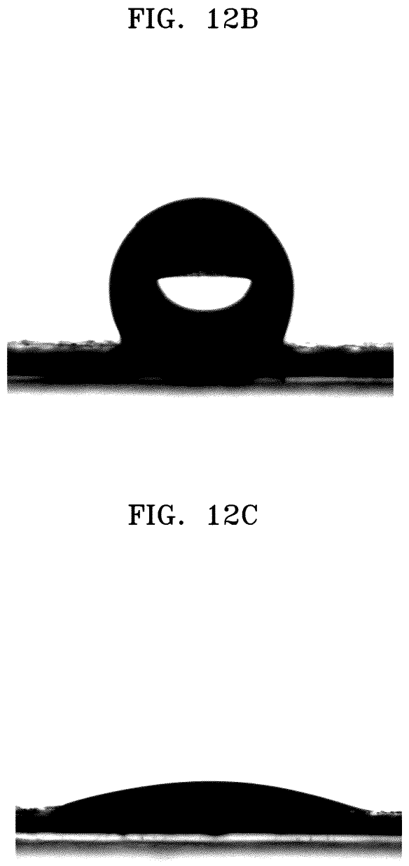

FIG. 12A shows the water contact angle of the CORE prepared in Example 1. In FIG. 12A, the water contact angle was 133.9 degrees.

FIG. 12B shows the water contact angle of the CORE prepared in Comparative Example 1. In FIG. 12B, the water contact angle was 120.6 degrees.

FIG. 12C shows the water contact angle of the CORE prepared in Comparative Example 2. In FIG. 12C, the water contact angle was 22.2 degrees.

As shown in FIGS. 12A to 12C, the catalyst layer of the CORE prepared in Example 1 had the highest hydrophobicity. Also, during the operation of a carbon oxide electrolyzer cell, the CORE prepared in Example 1 could more effectively suppress flooding as compared to the COREs prepared in Comparative Examples 1 and 2.

### Evaluation Example 3: Composition Analysis (I)

A catalyst content of each of the catalyst layers of the COREs prepared in Example 1, Comparative Example 1, and Comparative Example 2 was measured by using ICP, and a loading amount was calculated from the catalyst content. The catalyst content and the loading amount are shown in Table 2 below. A catalyst loading amount is a catalyst content per unit area of a catalyst layer.

TABLE 2

| | Catalyst content | Catalyst loading amount |
|---|---|---|
| | (ppm} | (mg/cm²) |
| Example 1 (Cu, DB | 0.913 | 45.65 |
| coating) | | |
| Comparative Example 1 | 7.835 | 391.75 |
| (Cu, spray coating) | | |
| Comparative Example 2 | 4.895 | 244.75 |
| (Cu, sputtering) | | |

As shown in Table 2, the catalyst content of the catalyst layer of Example 1 was 4 ppm or less, but the catalyst content of each of the catalyst layers of Comparative Examples 1 and 2 was more than 4 ppm. The catalyst loading amount of the catalyst layer of Example 1 was 200 μg/cm² or less, but the catalyst loading amount of each of the catalyst layers of Comparative Examples 1 and 2 was more than 200 μg/cm².

### Evaluation Example 4: Composition Analysis (II)

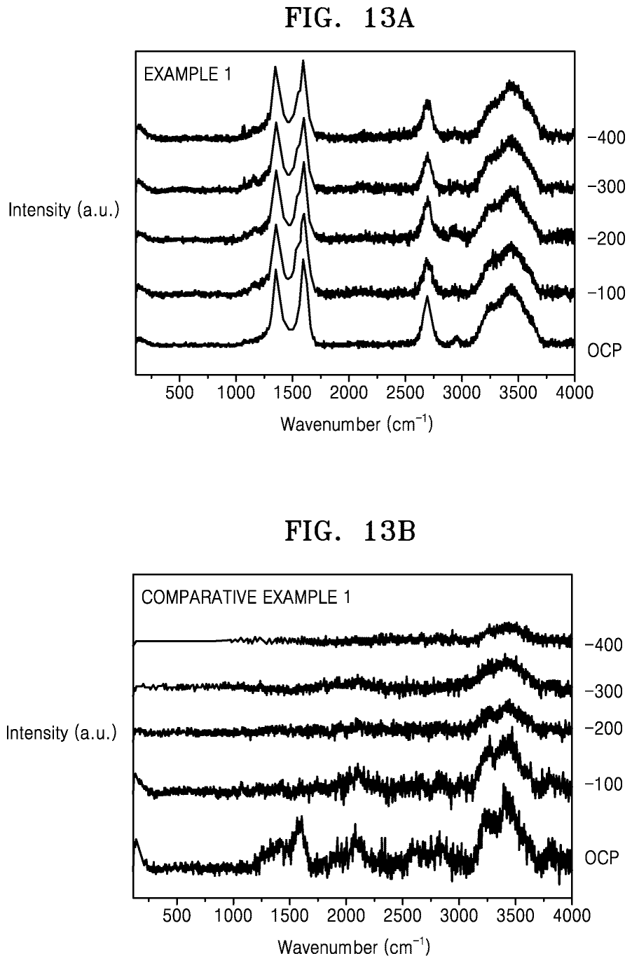

During the operation of the COREs prepared in Example 1 and Comparative Example 1, a surface state according to a current density of the catalyst layer of each of the COREs was analyzed through Raman spectroscopy analysis. Analysis results are shown in FIGS. 13A and 13B.

FIG. 13A shows a Raman spectrum according to a reduction current density of the catalyst layer of the CORE prepared in Example 1.

FIG. 13B shows a Raman spectrum according to a reduction current density of the catalyst layer of the CORE prepared in Comparative Example 1.

As shown in FIG. 13A, the catalyst layer of the CORE prepared in Example 1 exhibited a D band peak in a range of about 1,320 cm⁻¹ to about 1,440 cm⁻¹ and a G band peak in a range of about 1,480 cm⁻¹ to about 1,580 cm⁻¹ derived from a carbon-based material in the Raman spectrum. It was confirmed that the catalyst layer of the CORE prepared in Example 1 included a carbonaceous material including both crystalline and amorphous phases. As shown in FIG. 13B, the catalyst layer of the CORE prepared in Comparative Example 1 did not exhibit a peak derived from a carbon-based material in the Raman spectrum.

### Evaluation Example 5: Analysis of Catalytic Activity of Carbon Oxide Reduction Reaction

A reduction current density of carbon dioxide or carbon monoxide was measured on carbon oxide electrolyzer cells, which included the COREs prepared in Example 1, Comparative Example 1, and Comparative Example 2, and Al/AgCl reference electrodes, at a scan rate of 10 mV/s by using LSV.

Measurement results of the CORE prepared in Example 1 with respect to carbon dioxide and carbon monoxide are shown in FIG. 14A.

Measurement results of the CORE prepared in Comparative Example 1 with respect to carbon dioxide and carbon monoxide are shown in FIG. 14B.

In the CORE prepared in Comparative Example 2, measurement was impossible due to flooding.

As shown in FIG. 14A, at a high current density of −700 mA/cm², the overvoltage of a carbon dioxide (CO₂) reduction reaction of the CORE of Example 1 was −5.11 V (vs. Ag/AgCl), and the overvoltage of a carbon dioxide (CO₂) reduction reaction of the CORE of Comparative Example 1 was −5.51 V (vs. Ag/AgCl). In the CORE of Example 1, a current density according to a voltage had a constant gradient at a high current density of −700 mA/cm² or more. In the CORE of Comparative Example 1, a current density according to a voltage was irregular at a high current density of −700 mA/cm² or more and thus did not have a constant gradient.

As shown in FIG. 14B, at a high current density of −700 mA/cm², the overvoltage of a carbon monoxide (CO) reduction reaction of the CORE of Example 1 was −4.68 V (vs. Ag/AgCl), and the overvoltage of a carbon monoxide (CO) reduction reaction of the CORE of Comparative Example 1 was −5.11 V (vs. Ag/AgCl). In the CORE of Example 1, a current density according to a voltage had a constant gradient at a high current density of −700 mA/cm² or more. In the CORE of Comparative Example 1, a current density according to a voltage was irregular at a high current density of −700 mA/cm² or more and thus did not have a constant gradient.

It was shown that the CORE of Example 1 stably operated at a high current density and a high voltage during carbon dioxide reduction and carbon monoxide reduction.

### Evaluation Example 6: Evaluation of Carbon Monoxide (CO) Reduction Reaction Efficiency

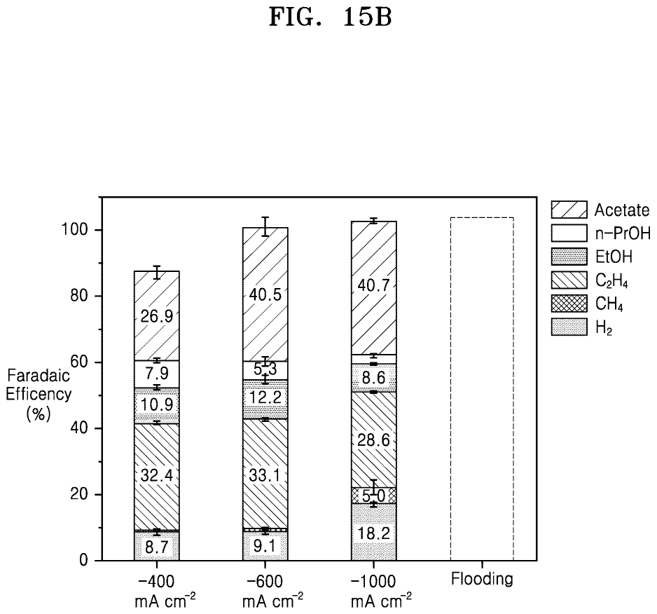

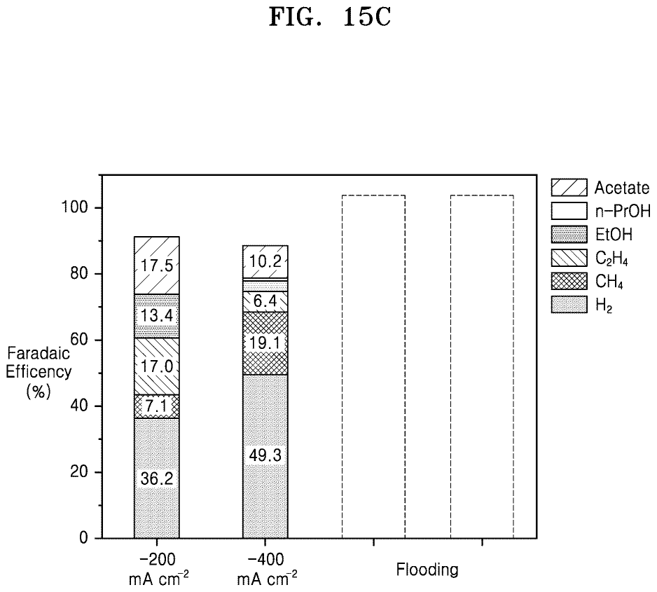

The faradaic efficiency of a carbon monoxide reduction reaction was evaluated on electrolyzer cells including the COREs of Example 1, Comparative Example 1, and Comparative Example 2 at current densities of −200 mA/cm², −400 mA/cm², −600 mA/cm², −800 mA/cm², −1,000 mA/cm², and −1,200 mA/cm². Evaluation results are shown in FIGS. 15A to 15C.

FIG. 15A is a graph showing a product distribution and the Faradaic efficiency according to a current density of the electrolyzer cell including the CORE of Example 1.

FIG. 15B is a graph showing a product distribution and the Faradaic efficiency according to a current density of the electrolyzer cell including the CORE of Comparative Example 1.

FIG. 15C is a graph showing a product distribution and the Faradaic efficiency according to a current density of the electrolyzer cell including the CORE of Comparative Example 2.

As shown in FIG. 15A, in the electrolyzer cell including the CORE of Example 1, flooding did not occur up to −1,200 mA/cm², and multi-carbon compound conversion efficiency was 86.6% or more at −1,200 mA/cm².

As shown in FIG. 15B, in the electrolyzer cell including the CORE of Comparative Example 1, flooding did not occur up to −1,000 mA/cm², and multi-carbon compound conversion efficiency was 73% or more at −1,000 mA/cm². At a current density exceeding −1,000 mA/cm², flooding occurred, and thus measurement was impossible.

As shown in FIG. 15C, in the electrolyzer cell including the CORE of Comparative Example 2, flooding did not occur up to −1,000 mA/cm², and multi-carbon compound conversion efficiency was 55% or more at −1,000 mA/cm². At a current density exceeding −400 mA/cm², flooding occurred, and thus measurement was impossible.

The electrolyzer cell including the CORE of Example 1 had improved water resistance as compared to the electrolyzer cells including the COREs of Comparative Examples 1 and 2, thereby suppressing flooding.

It was confirmed that the electrolyzer cell including the CORE of Example 1 provides stable operation at a high current density and an overvoltage, and can also provide improved multi-carbon compound conversion efficiency as compared to the electrolyzer cells of Comparative Examples 1 and 2.

### Evaluation Example 7: Evaluation of Stability Carbon Dioxide (CO₂) Reduction Reaction Over Time

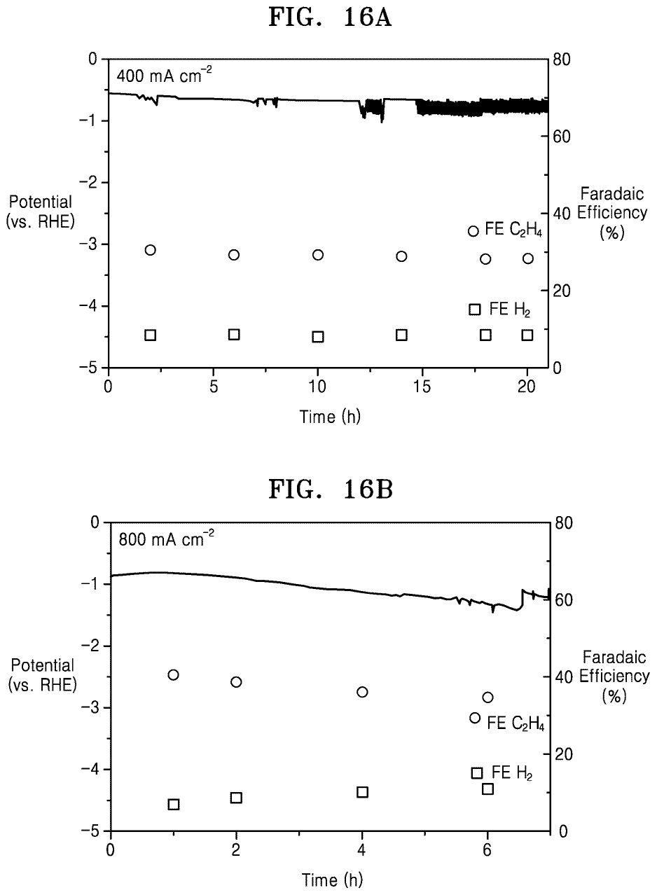

For the electrolyzer cells including the COREs of Example 1, and the reduction electrodes of Comparative Example 1 and Comparative Example 2, a change in faradaic efficiency of carbon dioxide reduction reactions (for example, an ethylene (C₂H₄) production reaction and a hydrogen (H₂) production reaction) over time was evaluated at current densities of −400 mA/cm² and −800 mA/cm². Evaluation results are shown in FIGS. 16A and 16B.

As shown in FIG. 16A, at a current density of −400 mA/cm², ethylene conversion Faradaic efficiency was 30% after 2 hours and 28.4% after 20 hours, and the ethylene conversion Faradaic efficiency after 20 hours was maintained to be 94% of initial ethylene conversion Faradaic efficiency. Although not shown in the drawings, in the electrolyzer cells including the reduction electrodes of Comparative Examples 1 and 2, flooding was observed within 10 hours.

As shown in FIG. 16B, at a current density of −400 mA/cm², ethylene conversion Faradaic efficiency was 40.61% after 1 hour and 35.44% after 6 hours, and the ethylene conversion Faradaic efficiency after 6 hours was maintained to be 85% of initial ethylene conversion Faradaic efficiency. Although not shown in the drawings, in the electrolyzer cells including the reduction electrodes of Comparative Examples 1 and 2, flooding was observed within 5 hours.

It was confirmed that the electrolyzer cell including the CORE of Example 1 was capable of stable operation for a relatively extended time as compared to the electrolyzer cells including the reduction electrodes of Comparative Examples 1 and 2.

While embodiments have been described in detail with reference to the accompanying drawings, the present inventive concept is not limited to the embodiments. It is obvious to those skilled in the art to which the present inventive concept belongs that various changes and modifications are conceivable within the scope of the technical idea described in the claims, and those are understood as naturally belonging to the technical scope of the present inventive concept.

According to an aspect, by including an MPCL, the water resistance of a CORE may be improved, thereby suppressing flooding.

According to an aspect, by including an MPCL, a CORE may perform a stable electrode reaction at a high current density.

According to an aspect, by including an MPCL, a CORE may maintain improved carbon oxide conversion efficiency for an extended period of time.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A carbon oxide reduction electrode (CORE) comprising:
a gas diffusion layer comprising a microporous substrate that includes conductive fibers; and
a microporous catalyst layer on the gas diffusion layer,
wherein the microporous catalyst layer comprises conductive particles and catalyst particles, and the microporous catalyst layer has a thickness of 10 micrometers or more.

2. The CORE of claim 1, wherein the microporous catalyst layer further comprises a porous structure formed by the conductive particles, and the catalyst particles are supported on the porous structure.

3. The CORE of claim 1, wherein the catalyst particles are present in a range of about 0.01 ppm to about 100 ppm as determined by inductively coupled plasma spectroscopy analysis of the microporous catalyst layer.

4. The CORE of claim 1, wherein the catalyst particles are present in a loading amount of about 1 μg/cm² to about 10 mg/cm² of the microporous catalyst layer.

5. The CORE of claim 1, wherein, in a Raman spectrum of the microporous catalyst layer, the microporous catalyst layer exhibits at least one of a D band peak in a range of about 1,320 cm⁻¹ to about 1,440 cm⁻¹ and a G band peak in a range of about 1,480 cm⁻¹ to about 1,580 cm⁻¹, and
a peak intensity ratio ID/IG of the intensity ID of the D band peak to the intensity IG of the G band peak is in a range of 0.1 to about 2.

6. The CORE of claim 1, wherein the microporous catalyst layer comprises a first side proximate to the gas diffusion layer and a second side opposite the first side, and
a catalyst concentration of a first area proximate to the first side is lower than a catalyst concentration of a second area proximate to the second side, as determined by energy dispersive spectroscopy analysis of a cross section of the microporous catalyst layer.

7. The CORE of claim 1, wherein the microporous catalyst layer comprises a first side proximate to the gas diffusion layer and a second side opposite the first side, and
the microporous catalyst layer has a catalyst concentration gradient in which a concentration decreases from the second side to the first side, as determined by energy dispersive spectroscopy analysis of a cross section of the microporous catalyst layer.

8. The CORE of claim 6, wherein the microporous catalyst layer has a catalyst concentration gradient in which a concentration continuously decreases from the second side to the first side, and
the catalyst particles are present in a loading amount of about 1 μg/cm² to about 200 μg/cm².

9. The CORE of claim 1, wherein the conductive particles comprise primary particles, secondary particles which are an aggregate of a plurality of primary particles, or a combination thereof, and
a diameter of the primary conductive particles is in a range of about 5 nm to about 500 nm.

10. The CORE of claim 1, wherein the conductive particles comprise carbon particles.

11. The CORE of claim 1, wherein the catalyst particles comprise copper particles, and
the copper particles comprise Cu, Cu₂O, CuO, Cu(OH)₂, or a combination thereof.

12. The CORE of claim 1, wherein the catalyst particles comprise primary particles, secondary particles which are an aggregate of a plurality of primary particles, or a combination thereof,
a diameter of the primary catalyst particles is 500 nm or less, and
a shape of the primary catalyst particles is spherical shape, a polyhedral shape, or a combination thereof.

13. The CORE of claim 12, wherein the primary particle diameter of the catalyst particles is 90% or less than a primary particle diameter of the conductive particles.

14. The CORE of claim 1, wherein the conductive fibers comprise carbon fibers, metal fibers, or a combination thereof and have a diameter of 30 μm or less and a length of 100 μm or more.

15. The CORE of claim 1, wherein at least one of the microporous substrate or the microporous catalyst layer comprises a hydrophobic binder,
wherein the hydrophobic binder comprises polytetrafluoroethylene, polytetrafluoroethylene-hexafluoroethylene, polyvinylidene fluoride, or a combination thereof, and
a content of the hydrophobic binder is 10 wt % or less with respect to a total weight of the microporous substrate and the microporous catalyst layer.

16. The CORE of claim 1, wherein a contact angle of the microporous catalyst layer is 130 degrees or more with respect to distilled water measured at a temperature of 25° C. and a pressure of 1 atm through a Sessil drop method.

17. A carbon oxide electrolyzer cell comprising:
the carbon oxide reduction electrode of claim 1;
an oxidation electrode; and
an electrolyte disposed between the carbon oxide reduction electrode and the oxidation electrode.

18. The carbon oxide electrolyzer cell of claim 17, wherein a current density and a voltage at a current density of −700 mA/cm² or more has a linear relationship, at a carbon oxide reduction current at a scan rate of 10 mV/s as determined by linear sweep voltammetry.

19. The carbon oxide electrolyzer cell of claim 17, wherein, after 20 hours of operation, faradaic efficiency of a reaction of obtaining ethylene from carbon oxide is 80% or more of initial faradaic efficiency.

20. A method of preparing a carbon oxide reduction electrode, the method comprising:
providing a first stack comprising a microporous substrate and a microporous layer disposed on the microporous substrate, wherein the microporous substrate contains conductive fibers, and the microporous layer comprises conductive particles;
coating the microporous layer of the first stack with a composition comprising a catalyst precursor to provide a second stack;
optionally, pressing the second stack to provide a third stack, wherein the third stack comprises a microporous precursor layer which comprises conductive particles and a catalyst precursor; and
heat-treating the first stack or the third stack to provide the carbon oxide reduction electrode comprising a microporous catalyst layer that includes conductive particles and catalyst particles,
wherein the microporous catalyst layer has a thickness of 10 micrometers or more.
